(19) United States
(12) Patent Application Publication
(10) Pub. No.: US 2006/0286199 A1
(43) Pub. Date: Dec. 21, 2006

(54) Method and composition for increasing omega-3 lipid in milk

(76) Inventor: Marilou Laprise, Alma (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/144,007

(22) Filed: Jun. 3, 2005

(51) Int. Cl. A23K 1/18

(52) U.S. Cl. 426/2

(57) ABSTRACT

The present invention relates to a product, composition and method of use thereof for inducing or increasing omega-3 lipid production in body fluids of human and animals. Particularly, the product consist in roasted flax seeds, fragments or derivatives thereof, which can be used in the preparation of a composition, preferably orally administered to the human or animal and causes the induction or increase of the production of omega-3 lipids by the secretory tissues. More particularly, the secretory tissues are mammary glands.

### FIELD OF THE INVENTION

The present invention relates to a composition and method for improving the production of omega-3 lipid production in body fluids of human and animals. Particularly, the present invention relates to increasing the content of omega-3 lipids in the milk of lactating animals through specific regimens.

### BACKGROUND ART

Omega-3 fatty acid oils possess properties that can be used for numerous therapeutic advantages, including treatment of autoimmune and inflammatory diseases such as rheumatoid arthritis, psoriasis, inflammatory bowel diseases such as Crohn's disease and ulcerative colitis; immunosuppressive treatment; hypertension prophylaxis in normal humans and in heart transplant patients; coronary heart disease; hyperlipidemia; hypertriglyceridemia; improvement of renal function and nephrotoxicity reduction. U.S. Pat. No. 4,678,808 describes the use of these oils to treat disorders associated with arachidonic acid metabolites, including autoimmune syndromes, acute and chronic inflammatory diseases, atherosclerosis, stroke, myocardial infarction, deep vein thrombosis, surgery, hyperlipidaemic states, hypertension, enhanced platelet responsiveness, vascular lesions and occlusions, vascular spasm and diabetes. According to U.S. Pat. No. 5,225,441, which describes compositions for treating gingivitis and periodontitis, omega-3 polyunsaturated fatty acids compete with omega-6 polyunsaturated fatty acids as a substrate in the arachidonic acid cascade and can therefore alter the synthesis of prostaglandin and leukotrienes, both of which are powerful mediators of inflammation and immune response. Other uses of omega-3 fatty acid oils are described in U.S. Pat. No. 5,034,415 (diabetes mellitus), U.S. Pat. No. 4,843,095 (rheumatoid, arthritis), JP 2253629 (anticancer), U.S. Pat. No. 4,879,312 (enhancing angiogenesis), JP 1290625 (improvement of cerebral function), EP 378,824 (anti-cachexia, cholesterol and triglyceride levels reduction, platelet aggregation inhibition, colon adenocarcinomas growth inhibition), U.S. Pat. No. 5,457,130 (cancer cachexia, malignant tumors, abnormal cAMP levels in adipose tissue, lipolytic activity inhibition) and U.S. Pat. No. 5,436,269 (hepatitis).

Currently the only commercially available dietary source of omega-3 highly unsaturated fatty acids is from certain fish oils which can contain up to 20-30% of these fatty acids. The beneficial effects of these fatty acids can be obtained by eating fish several times a week or by daily intake of is concentrated fish oil. Consequently large quantities of fish oil are processed and encapsulated each year for sale as a dietary supplement.

However, there are several significant problems with these fish oil supplements. First, they can contain high levels of fat-soluble vitamins that are found naturally in fish oils. When ingested, these vitamins are stored and metabolized in fat in the human body rather than excreted in urine. High doses of these vitamins can be unsafe, leading to kidney problems or blindness and several U.S. medical associations have cautioned against using capsule supplements rather than real fish. Secondly, fish oils contain up to 80% of saturated and omega-6 fatty acids, both of which can have deleterious health effects. Additionally, fish oils have a strong fishy taste and odor, and as such cannot be added to processed foods as a food additive, without negatively affecting the taste of the food product. Moreover, the isolation of pure omega-3 highly unsaturated fatty acids from this mixture is an involved and expensive process resulting in very high prices ($200-$1000/g) for pure forms of these fatty acids

It has been shown beneficial for humans to consume eggs enriched with Omega-3 fatty acids for numerous reasons. There is a link between dietary n-3 fatty acid consumption and a decreased incidence of cardiovascular disease. In addition, consumption of Omega-3 fatty acid enriched eggs improves a person's HDL:LDL cholesterol ratio. Furthermore, enriched eggs are able to reduce a person's serum triglyceride levels. Although consumption of Omega-3 fatty acids is beneficial, dietary sources of these fatty acids are limited to certain types of fish and oilseed such as flax. Thus, incorporating these beneficial fatty acids into eggs provides an additional dietary n-3 fatty acid source for consumers.

U.S. Pat. Nos. 5,985,348 and 6,177,108, discloses a process for the heterotrophic or predominantly heterotrophic production of whole-celled or extracted microbial products with a high concentration of omega-3 highly unsaturated fatty acids, producible in an aerobic culture under controlled conditions using biologically pure cultures of heterotrophic single-celled fungi microorganisms of the order Thraustochytriales. The harvested whole-cell microbial product can be added to processed foods as a nutritional supplement, or to fish and animal feeds to enhance the omega-3 highly unsaturated fatty acid content of products produced from these animals. The lipids containing these fatty acids can also be extracted and used in nutritional, pharmaceutical and industrial applications. This has the disadvantage of requiring microorganisms manipulations en a feeding environment.

A new method for producing Omega-3 fatty acid enriched milk is needed which produces milk of a desirable flavor. In addition, a method is needed which is able to ensure a predetermined amount of Omega-3 fatty acids are consistently provided in milk. Still further, a diet for milking animals needs to be available which increases the amount of Omega-3 fatty acids in their milk without causing adverse effects.

### BRIEF DESCRIPTION OF THE FIGURES

FIG. 1 illustrates the concentration of alpha-linolenic acid regarding treatments of flax seeds;

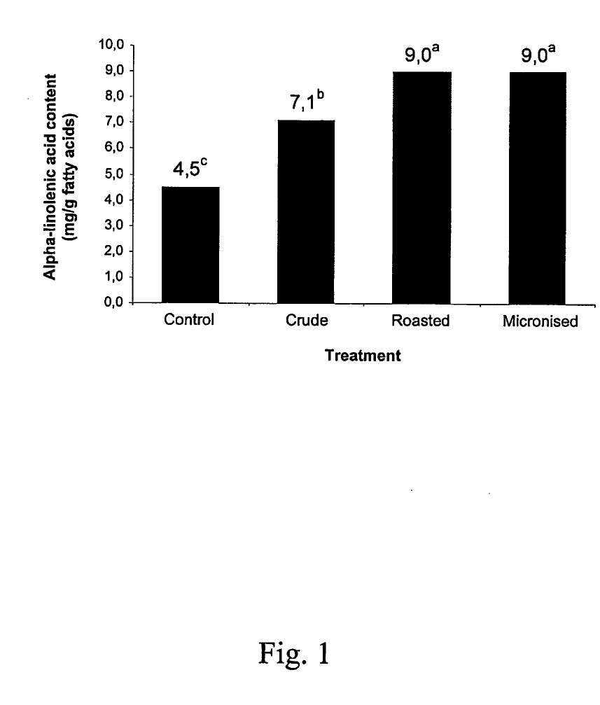

FIG. 2: illustrates the difference between milk production of cows that received the reference feed and those that received flax seeds;

FIG. 3 illustrates the total milk omega-3 fatty acid content (C18:3; C20:5 and C22:5) had increased when the cows were fed with flax seeds; and

FIG. 4 illustrates the average quantities of C18:3 in fatty acids in function of different treatments.

### SUMMARY OF THE INVENTION

One aim of the present invention is to provide a method for inducing or increasing omega-3 lipid production by secretory tissue in a human or an animal comprising orally administering to said human or animal roasted flax seeds, fragment or derivatives thereof at a concentration inducing increase of the production of omega-3 in said secretory tissue. The flax seeds can be for example given as a whole, crushed, fragmented, or grinded.

The secretory tissue is preferably mammary glands of a lactating animal, such as but not limited to, a cow, a sheep, or a goat.

According to another aim of the present invention, there is provided a composition comprising roasted flax seeds for inducing or increasing omega-3 lipid production by secretory tissue in a human or an animal.

The composition can be under form of a food composition.

In accordance with the present invention there is provided a use of roasted flax seed, a fragment or a derivative thereof for inducing or increasing omega-3 lipid production by secretory tissue of a human or an animal.

In accordance with the present invention there is provided a use of roasted flax seeds, a fragment or a derivative there of in the preparation of a composition for inducing or increasing omega-3 lipid production by secretory tissue of a human of an animal.

### DESCRIPTION OF THE PREFERED EMBODIMENTS

The present invention now will be described more fully hereinafter with reference to the accompanying drawings, in which preferred embodiments of the invention are shown. This invention, may, however, be embodied in many different forms and should not be construed as limited to the embodiments set forth herein; rather, these embodiments are provided so that this disclosure will be thorough and complete, and will fully convey the scope of the invention to those skilled in the art.

Flax seed oil is a blue flowering plant that is grown in several countries for its oil rich seeds. This natural oil (also known as Linseed Oil) is highly recommended for the general well being and whole body nutrition and is considered to be nature's richest source of omega-3 fatty acids that are required for the health of almost all body systems.

Flax seed oil contains omega-6 and omega-9 essential fatty acids, B vitamins, potassium, lecithin, magnesium, fiber, protein, and zinc and also provides approximately 50% more omega-3 oils than what you could get from taking fish oil.

It has been discovered by the inventors and described herein that oral administration of roasted flax seeds, fragment or derivatives thereof, allow to improve or increase the production of omega-3 lipids in body fluids of animals, including human.

One embodiment of the present invention is to provide a method for causing or increasing omega-3 lipids production in body fluids of human and animals. Particularly, the method is performed by orally administering to human being and animals targeted quantities of roasted flax seeds, fragment or derivatives thereof to induce, improve or increase the production of omega-3 lipids by secretory body tissues. Oral ingestion of roasted flax seeds, fragments or derivatives thereof induce or increase omega-3 lipid production, for example in milk, that can vary from between about 1,00% to 1,4% of total milk fatty acids measured according to the present invention.

For example, but not limited to, when flax seeds, after roasting, are added to cow regimen for feeding, the cows ingesting this regimen are induced to produce higher concentrations of omega-3 lipids in their milk then those cows having not ingested the regimen comprising the roasted flax seeds, fragment or derivatives thereof.

Roasting initially is endothermic; i.e. heat transferred to flax seeds raises their sensible heat content, evaporates water and provides heat used in endothermic reactions. After seed temperatures reach, for example, 130° C., rapid exothermic reactions occur, seed temperatures rapidly rise and flax seeds characteristics are very rapidly acquired. Excessive weight loss and undesirable characteristics changes occur if roasting is excessively prolonged. Therefore, to end roasting quickly and provide flax seeds of desired, reliably duplicated quality, seeds most commonly are rapidly cooled (quenched) as soon as they reach a selected end-of-roast temperature. First, a controlled amount of water, can be sprayed on the seeds and largely evaporates, providing evaporative cooling. Then, the seeds can be cooled further by forced contact with ambient-temperature air. The roasting temperature may vary between 110° C. to 140° C., for example at a treatment rate of 3 tons/hour.

Different roasting methods that are currently used for other types of grains, such as coffee grains, can be applied to flax seeds to allow the different embodiments of the present invention. Among the most recent systems, various proposals have been advanced, as for example, for high-pressure roasting systems. Notably, numerous patents issued to Horace L. Smith Jr. describe batch or continuous systems for pressure-roasting of coffee in rolling fluidized beds or spouted beds.

A “fluidized bed” system directs a gas or other fluid upwardly through a mass of particulates such as coffee beans, or flax seeds, so that the particulates are held suspended in the rising fluid. Ideally, the upward flow is nearly uniform in all regions of the bed.

A “spouted bed” system utilizes upward flow of the gas or other fluid concentrated at a few locations within the bed. The particles move upwardly at these locations and downwardly at other locations in the bed. Most of the Smith patents call for use of pressurized, low-oxygen-content gas circulating in a closed loop through: a heater, a bed of roasting coffee in a heavy-walled, cylindrical chamber and a cyclonic separator. The cyclonic separator removes small particles, commonly referred to as “chaff” from the gas. Some other techniques use gas pressures up to 300 psig (2.1 MPa gauge). In a specific example, Robustas were roasted at 150 psig to improve their flavor. The roasting gas is heated by indirect contact with either a high-temperature, heatexchange fluid or hot gases produced in a fuel-fired furnace. To modify the roasting effects, part of the roasting gas can be bled off in some cases and replaced by inert gas produced by combustion of fuel. It will be recognized to those skilled in the art that other more conventional methods can be used to performed roasting of flax seeds according to the present invention.

Another embodiment of the present invention resides in a composition comprising roasted flax seeds, fragments or derivatives thereof. The composition may consists in a food composition comprising different other products, such as for example, but not limited to, flavouring or coloring agents, fibres, lipids, glucids, and any other compound or product that can be useful for feeding human or animals.

Also, synthetic antioxidants, such as BHT, BHA, TBHQ or ethoxyquin, or natural antioxidants such as tocopherol, can be incorporated into the food or feed products by adding them to the products during processing of the cells after harvest. The amount of antioxidants incorporated in this manner depends, for example, on subsequent use requirements, such as product formulation, packaging methods, and desired shelf life.

It is understood herein that roasted flax seeds can be ingested by human or animals under different forms, such as being crude, roughly grinded, or into the form of a powder, pellets, capsules, a paste, or any other form that can be seen in the field of feeding. It can also be mixed to other food products into different forms seen in the art.

One embodiment of the present invention is the use of roasted flax seeds in the preparation of a composition for inducing, improving, or increasing omega-3 lipid production in body fluids of human and animals. Particularly, roasted flax seeds are used in feeding milking animals and induce or increase the production of omega-3 lipids in their milk. Preferred animals for milk product production include milk-producing animal, in particular cows, sheep, goats, bison, buffalo, antelope, deer and camels. More preferred animals for milk product production include cows, sheep and goats.

Methods to feed roasted flax seeds, fragment or derivatives thereof-containing material to an animal that is a ruminant (i.e., cow, sheep or goat) can require some encapsulation technique for to protect the important elements of roasted flax seeds, such as omega-3 lipids, from breakdown or saturation by the rumen microflora prior to digestion and absorption of the omega-3 by the animal. Alternatively, the active elements can be “protected” by coating the oils or cells with a protein (e.g., zeain) or other substances which cannot be digested (or are poorly digested) in the rumen. This allows the fatty acids to pass undamaged through the ruminant's first stomach. The protein or other “protectant” substance is dissolved in a solvent prior to coating the cells or oil. The cells can be pelleted prior to coating with the protectant. Animals having high feed conversion ratios can require higher concentrations of roasted flax seeds to achieve an equivalent incorporation of important elements as animal with low feed conversion ratios.

The present invention will be more readily understood by referring to the following examples which are given to illustrate the invention rather than to limit its scope.

### EXAMPLE I

### Preparation of an Omega-3 Lipid Rich Food Composition

Materials and Methods

Choice of Treatments

Three flax seed treatments were experimented and compared to a reference treatment. The first treatment contained raw flax seeds, not having been submitted to no physical or chemical treatment, the second contained roasted flax seeds and the third, micronized flax seeds. Roasting is a process where the grains are heated at a temperature of about 130° C. by means of a propane flame that is fed with propane. For micronizing, we are also concerned with a heating process, however this is achieved with infrared rays. The temperature is raised to 110° C. For the reference feed, flax seeds were substituted with the same proportions of rolled barley.

The various treatments with flax seeds were modified with respect to what has been provided in the initial protocol. As a matter in fact, it has appeared that extrusion was a treatment that was hardly applicable to a seed that is so rich in oil and the results obtained by Arif Mustafa (cited by Yvan Chouinard, 2002) of McGill University, have established that extruded flax seeds did not allow an efficient transfer of omega-3 fatty acids. This treatment was thus replaced by one that is equivalent, i.e. roasting as described hereinabove. As a matter of fact, this process uses heat to treat the seed. Heat treatment allows to increase the availability of the non degradable protein.

Cross-over design (repeated measurements) in latin square was retained as experimental device. To meet the requirements of this device, eight cows were bought, and a cow from the application Farm was selected. Eight animals were required for achieving the tests and an additional cow was kept in stand-by, in case one of the selected animals had to be replaced. Table 1 gives the characteristics of the animals used during the tests.

TABLE 1
Characteristics of the animals participating in the project

| | | | Number of | |
|---|---|---|---|---|
| Number | Pair | Race | calvings | Milking days |
| 1 | 1 | HO | 1 | 50 |
| 2 | 2 | AY | 3 | 67 |
| 3 | 3 | AY | 1 | 49 |
| 4 | 3 | HO | 1 | 80 |
| 5 | 1 | AY | 3 | 67 |
| 6 | 4 | HO | 2 | 48 |
| 7 | 4 | AY | 1 | 78 |
| 8 | 2 | HO | 2 | 67 |
| 9 | substitute | AY | 1 | 52 |

Therefore, four Holstein (HO) and four Ayrshire (AY) cows were used to conform to the latin square. Each Holstein animal was used, at random, with an Ayrshire animal for the application of different feeds. The animals were all in initial lactation stage for an average of 62 milk days. The cow which was less advanced in her lactation was at her 48^{th} day and the most advanced was at yer 80^{th} day, which is a spread of 32 days. Half of the animals were primipara and the other half were multipara.

Preparation of Feeds

Each animal received a personalized feed depending on its weight, its food intake and it milk production. The software Conseil-Lait II (3.10 version) of Agri-Gestion Laval was used for equilibrating the feeds.

Fudder

The fudder was distributed at will during the first two weeks for each period. In the third week, the amounts distributed to each animal and the amounts not eaten were weighed, in order to determined the food intake.

Concentrates

A complete milling was used, in order satisfy the needs of the animals, as well as Toplac, if necessary. Moreover, depending on the treatment, the animals received 2 kg of one of the three types of flax seeds or 2 kg of barley for the reference group. Table 2 gives feed sequences and average times for the meals.

TABLE 2
Cow feeding sequence

| Meal | Average time | | Distributed food | Quantities given (TQS)¹ |
|---|---|---|---|---|
| Meal 1 | 6:30 | am | Hay | 4 kg/cow |
| | 7:00 | am | Milling | Individual feed |
| | 7:15 | am | Mixed silage² | 5 kg/cow |
| Meal 2 | 10:30 | am | Milling | Individual feed |
| | 10:45 | am | Alf. silage³ | 5 kg/cow |
| Meal 3 | 2:30 | pm | Milling | Individual feed |
| | 2:45 | pm | Hay | 5 kg/cow |
| Mean 4 | 5:30 | pm | Milling | Individual feed |
| | 6:00 | pm | Mixed silage | 8 kg/cow |

¹TQS: as given
²Mixed silage: Mixture of legumes and graminaceae
³Alf. silage: alfafa silage

The animals received four meals of concentrate per day, in order to maintain a greater stability with respect to rumen and for a better protein-energy synchronism.

Experimentation and Data Taking

Duration of Feeding Tests

The feeding tests took place from Feb. 28 to May 21, 2002. This represents a 12 week duration, i.e. four periods of three weeks (21 days) each. The number of periods was determined by the experimental device that was selected. With respect to the period duration, the first two weeks allowed the animals to get used to the feed and the last week was used to take data.

Experimental Scheme

This section shows the different food treatments given to the animals. As mentioned previously, eight cows were under experimentation and each one of them received the different treatments. Table 3 gives the experimental scheme.

TABLE 3
Experimental plan

| Number | Period 1 | Period 2 | Period 3 | Period 4 |
|---|---|---|---|---|
| 1 | Roasted flax seeds | Reference | Raw flax seeds | Micronized flax |
| | | | | seeds |
| 2 | Reference | Raw flax seeds | Micronized flax | Roasted Flax seeds |
| | | | seeds | |
| 3 | Micronized flax | Roasted flax seeds | Referebce | Raw flax seeds |
| | seeds | | | |
| 4 | Micronized flax | Roasted flax seeds | Reference | Raw flax seeds |
| | seeds | | | |
| 5 | Roasted flax seeds | Reference | Raw flax seeds | Micronized flax |
| | | | | seeds |
| 6 | Raw flax seeds | Micronized flax | Roasted flax seeds | Reference |
| | | seeds | | |
| 7 | Raw flax seeds | Micronized flax | Roasten flax seeds | Reference |
| | | seeds | | |
| 8 | Reference | Raw flax seeds | Micronized flax | Roasted flax seeds |
| | | | seeds | |

The number attributed to the position of the animal in the stable, and the treatment orders were given at random.

Weighing of Quantities Given and not Eaten.

Fodder and supplements were manually distributed all along the tests. In the last week of each period, the quantities of fodder distributed and not eaten were weighed. The food intake was therefore measured for each animal, and this was done for each treatment. The amounts of concentrate were weighed at each meal for the complete duration of the tests.

Weighing of Animals

An electronic scale was used to weigh the animals. They were weighed on the last two days of each period, after the morning milking. The scale was calibrated a the farm and was not displaced nor used for other purposed during the tests.

Milk Analyses

The quantities of milk produced were measured, for each animal, during the four last milking of each period. The milk gauge content was poured in containers and was rapidly cooled to 9° C., by means of a cold water cooling system. Then, the milk was stored in a refrigerator at 4° C. These four samples were then amalgamated into a single one.

From this sample, that is obtained from the four cow milking, three small samples were taken. The first one was intended for the PATLQ to determine fat, protein and lactose ratios, somatic cell count and milk urea concentration. The second one was kept at −18° C. to carry out milk fatty acid profile and a third sample, was also kept at −18° C., in order to mitigate anything unexpected. The unused milk was sent to the Laiterie de la Baie ltée laboratory for milk shelf live tests.

Moreover, during the last two milking of each period, some milk was recovered and cooled, through the same cooling system, for tasting. When the milk was at a temperature of 9° C., it was stored in a refrigerator at 4° C. This milk was sent already on the next morning to CARA for sensorial evaluation tests.

Fatty Acid Analyses

The fatty acid profile for each of the 32 samples (8 cows×4 milking) was carried out at Laval University. In all, 17 fatty acids were analyzed. The names and characteristics of these fatty acids are presented in section 5.4.

Compilation of Data

Taking of data concerning milk production was carried out for a period of two days. An average for each animal was therefore used for statistical analyses.

An average of two weighing was also calculated for analyzing the weight of the animals under experimentation.

The sum of the amounts of fodder that was eaten was carried out every day and an average, for the seven days of data taking, was then calculated. From the ratio of the dry matter contained in the food, it was possible to determine the dry matter consumption for each animal, and this for each period.

With the data obtained, it was possible to calculate food efficiency (kg of milk produced/kg of dry matter ingested) and the energy efficiency (kg of milk produced/ingested Mcal).

Analysis of Results

The data taken during the feeding tests were statistically analyzed, in order to show the effects of the treatments on the production parameters.

Dairy Production

Dairy production is the quantity of milk produced, in kg/day, expressed on a fatty material basis corrected to 4%. Fatty material and protein productions were also analyzed.

Milk Composition

Milk composition comprises five parameters and the analysis was made by infrared at the PATLQ laboratories.

Fat Ratio

This is the percentage of fat that is present in the sample analyzed. This parameter is very important for milk producers, because milk value is calculated as a function of is fat content.

Protein Ratio

As with the fat ratio, this represents the protein percentage that is present in the sample analyzed. This parameter is important, because milk value is also calculated as a function of its protein content.

Lactose Ratio

This is the lactose and other solid ratio that is found in the sample. Lactose is in fact the sugar portion of milk. It is a combination of glucose and galactose. Lactose does not have a monetary value that is as important as fat and protein, however it is part of the components that influence the price of milk.

Count of Somatic Cells

This measurement is expressed in thousands of somatic cells per milliliter (0.000/ml). If the cell count is high, this is an indication that the cow uses its immunological system (leucocytes) to fight a pathogenic agent in its udder (mammite). This data allows to explain certain anomalies (e.g. noted decrease of milk production).

Urea

The urea milk content is expressed in milligram of nitrogen per deciliter (mg N/dl). This measurement allows to see if the protein content of the feed is adequate.

Fatty Acid Analyses

The fatty acid profiles were statistically analyzed. They are expressed in percentage of the total quantity of fat. Therefore, the quantity of fat that is present in milk will have an influence on the quantity of fatty acids present.

Shelf Live

Preliminary tests were carried out with respect to milk shelf life, however more extended analyses should be carried out. Shelf life was evaluated by comparing taste, odor and pH of the reference with those of the modified milks. The quantity of bacteria that are present was also compared.

Statistical Analyses

The statistical model used is a 4×4 latin square. Data processing was carried out by means of the software SAS (1996), according to the GLM procedure (General Linear Models Procedure). The treatment effects on the different parameters were obtained from Duncan tests. The probability level was then 5% (P<0.05).

Results and Discussion

Dairy Production

Dairy production was measured on the last two days of each period, by means of a milk gauge. The results of statistical analyses have shown that the dairy production corrected to 4% of fat was not significantly different with respect to the different treatments (table 1).

Therefore, the production was not negatively affected by inserting flax seeds in the feeds. This represents a positive result, because the dairy producers who could resist the use of flax seeds in their animal feed, by fear of seeing a decrease in their production, will be reassured. On the other hand, since the animals used did not have a high dairy production, it would probably be interesting to pursue this investigation with high producing cows.

Milk Components

In general, as shown in table 1, the milk composition of cows having received flax seeds is not different from that of the reference milk. As a matter of fact, with respect to fat and proteins, there is no significant difference between the reference and flax seeds treatments. However, with respect to lactose, significant differences have been observed between the reference and roasted flax seeds and between roasted flax seeds and micronized flax seeds.

Moreover, significant differences were observed between different flax seed treatments. Indeed, the fat ratio of roasted flax seeds is significantly higher than that of micronized flax seeds.

TABLE 4
Voluntary food consumption of dry matter (CVMS), live weight, milk production
and milk composition of animals receiving differently treated flax seeds

| | | | | Micronized flax |
|---|---|---|---|---|
| Component | Reference | Raw flax seeds | Roasted flax seeds | seeds |
| Total CVMS (kg | 19.6^{a} | 19.6^{a} | 19.2^{a} | 19.6^{a} |
| d.m./d/cow) | | | | |
| Concentrates (kg | 8.5^{a} | 8.5^{a} | 8.3^{a} | 8.6^{a} |
| d.m./d/cow) | | | | |
| Fodders (kg d.m./d/cow) | 11.1^{a} | 11.1^{a} | 10.9^{a} | 11.0^{a} |
| Live weight (kg/cow) | 560^{a} | 557^{a} | 556^{a} | 554^{a} |
| Milk production, corrected | 22.5^{a} | 22.1^{a} | 22.0^{a} | 21.9^{a} |
| to 4% of fat (kg/d/cow) | | | | |
| Fat (%) | 3.63^{ab} | 3.68^{ab} | 3.91^{a} | 3.55^{b} |
| Protein (%) | 3.24^{a} | 3.24^{a} | 3.25^{a} | 3.33^{a} |
| Lactose (%) | 4.55^{b} | 4.59^{ab} | 4.67^{a} | 4.57^{b} |

(The values followed by the same letter, for the same component, are not significantly different close to 5%).

Dry Matter Consumption

The results obtained show that the addition of 2 kg of flax seeds in the feed has no influence on the animal dry matter consumption.

The fodder was distributed at will and is therefore representative of what the animals wanted to eat. Their consumption was not influenced by the different treatments.

Live Weight

It should be noted that during the experiment, the minimum measured weight was 451 kg and the maximum weight was 734 kg. The weight of the animals did not vary as a function of the treatment. The amount of flesh was therefore not affected by the addition of flax seeds to the feed.

Results of Fatty Acid Profiles

When determining the milk fatty acid profile, 17 different fatty acids were measured. The fact of increasing the quantity of omega-3 fatty acids in milk fat necessarily had an effect on the concentration of other fatty acids. The results for all fatty acids are therefore shown in this section.

Table 5 shows the fat composition of different milks. The results presented in this graph represent the sums of different types of fatty acids.

As shown in Table 3, the composition of fat was modified by the addition of flax seeds in the feed. The proportion of saturated fatty acids varied from 71.5% for the reference to 64% for flax seeds, 64.9% for roasted flax seeds and 63.2% for micronized flax seeds. This represents decreases of 7.5%, 6.6% and 8.3% respectively with respect to the reference. Since saturated fatty acids are bad for health, their decrease in the milk fat will make milk better for health.

The amount of unsaturated fatty acids has increased, as well as the quantity of essential fatty acids. These fatty acids are beneficial to health.

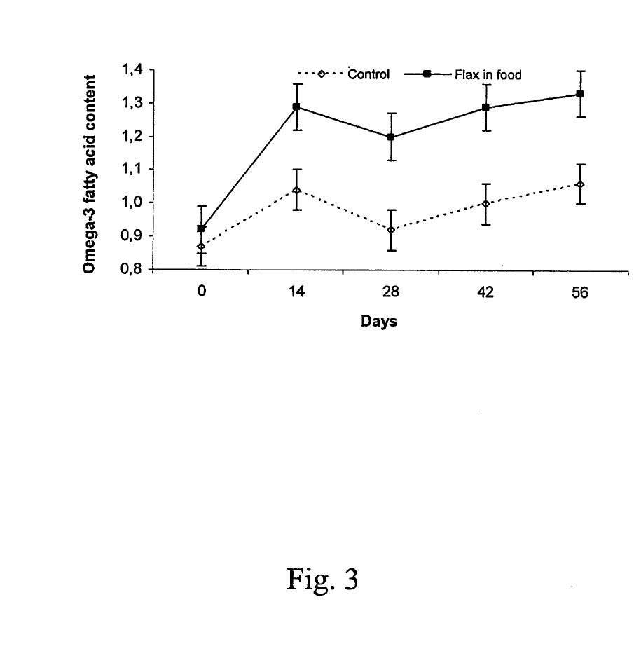

FIG. 3 gives the percentage of omega-3 fatty acids in milk fat as a function of the treatment of different milks.

TABLE 5
Fatty acid profile of milk produced by cows receiving differently treated flax seeds

| | | | Raw flax | Roasted flax | Micronized |
|---|---|---|---|---|---|
| Usual name | Fatty acids | Reference | seeds | seeds | flax seeds |
| Butyric acid | C4:0 | 2.52a | 2.47^{a} | 2.50^{a} | 2.37^{a} |
| Caproic acid | C6:0 | 2.42^{a} | 2.09^{b} | 2.09^{b} | 2.04^{b} |
| Caprylic acid | C8:0 | 1.36^{a} | 1.07^{b} | 1.07^{b} | 1.06^{b} |
| Capric acid | C10:0 | 3.04^{a} | 2.15^{b} | 2.15^{b} | 2.15^{b} |
| Lauric acid | C12:0 | 4.10^{a} | 2.77^{b} | 2.74^{b} | 2.83^{b} |
| Myristic acid | C14:0 | 12.29^{a} | 9.49^{b} | 9.45^{b} | 9.75^{b} |
| Myristoleic acid | C14:1 | 0.92^{a} | 0.62^{bc} | 0.56^{c} | 0.74^{b} |
| Pentadecanoic acid | C15:0 | 1.19^{a} | 1.00^{bc} | 0.96^{c} | 1.08^{ab} |
| Palmitic acid | C16:0 | 31.84^{a} | 23.34⁴ | 24.11^{b} | 23.70^{b} |
| Palmitoleic acid | C16:1 | 1.09^{a} | 0.80^{bc} | 0.74^{c} | 0.85^{b} |
| Margaric acid | C17:0 | 0.69^{a} | 0.63^{b} | 0.63^{b} | 0.65^{ab} |
| Stearic acid | C18:0 | 12.06^{b} | 18.99^{a} | 19.17^{a} | 17.59^{a} |
| Trans oleic acid | C18:1 | 1.71^{c} | 2.36^{b} | 2.68^{a} | 2.53^{ab} |
| | trans | | | | |
| Cis oleic acid | C18:1 cis | 21.48^{b} | 28.64^{a} | 27.04^{a} | 28.55^{a} |
| Linolenic acid | C18:2 | 2.24^{b} | 2.28^{ab} | 2.55^{a} | 2.53^{a} |
| Alpha-linolenic acid (n-3) | C18:3 | 0.45^{c} | 0.71^{b} | 0.90^{a} | 0.90^{a} |
| Conjugated linoleic acid | ALC | 0.59^{b} | 0.63^{ab} | 0.72^{a} | 0.68^{an} |

(The value followed by the same letter, for the same acid, are not significantly different, to a level of 5%).

### EXAMPLE II

### Feeding with the Omega-3 Composition

Materials and Methods

To carry out the feeding test, twelve dairy farms were enlisted in the Saguenay-Lac-Saint-Jean (6 farms) and Quebec (6 farms) regions. In total, 392 cows participated in the project, among them 203 received oleaginous flax seeds. The characteristics of the selected farms are presented in Table 1.

The animals were divided into two groups (flax seeds and reference) and in a manner that their characteristics be similar. Indeed, dairy production, protein and milk fat contents, as well as the average number of days of milk production and the average lactation number, were the same. With respect to the food used at the farms and the feeding methods, they were for their part somewhat diversified.

Roasted oleaginous flax seeds were distributed to about half the members of each herd while the other half has maintained the feeding already used at the farm. Flax seeds were distributed in a manner that the fat ratio be close to 5% of the feed. Thus, the quantity varied depending on the food used at the farm, the lactation stage and the animal consumption. The average quantity that was distributed was 1.3 kg/cow/d (0.9 to 2.0 kg/cow/d). Flax seeds replaced part of the concentrates of the initial feed in order to obtain isoenergetic and isoproteic feeds.

Adjustment of the fee was carried out in collaboration with the food adviser of each producer involved. Generally, the total quantity of concentrates (flax seeds included) that was distributed had increased. Indeed, the average quantity of concentrates has gone from 8.0 kg/cow/d to 8.5 kg/cow/d with the addition of flax seeds. Therefore, 1.3 kg of flax seeds/cow/d replaced about 0.8 kg of concentrates/cow/d. Moreover, in order to ensure a mineral equilibrium, some producers had to increase the quantity of minerals that were distributed during the addition of flax seeds in the feed. This is due to the fact that the fat (flax seed oil) is bound to calcium and magnesium in the rumen, thus decreasing the availability of these elements.

The animals received flax seeds during eight weeks (56 days). The milk production for each cow was determined every second week (i.e. on days 0, 14, 28, 42 and 56) by a technician. The latter also took samples that were analyzed by the Analysis Program of the Quebec Dairy Herds, in order to determine milk composition, somatic cell count and milk urea content.

Moreover, when taking data at the farms, reference and modified milk pools were constituted at all the farms by mixing the milk that has been collected in the milk gauges during two consecutive milking. The modified and reference milks, thus collected, were analyzed so as to determine the fatty acid profile.

TABLE 6
Characteristics of the farms selected

| | | | | Proteines (%) | | Fat (%) | | Production (kg/j) | | | | | | Lactation | |
|---|---|---|---|---|---|---|---|---|---|---|---|---|---|---|---|
| | | Number of cows | | (day 0) | | (jour 0) | | (day 0) | | Milk days | | | | number | |
| No. | Specy | Flax | Control | Flax | Control | Flax | Control | Flax | Control | Flax | | Control | | Flax | Control |
| 1 | Holstein | 18 | 13 | 3.41 | 3.45 | 3.91 | 4.11 | 22.9 | 24.6 | 211 | (7-464) | 177 | (14-513) | 2.7 | 2.0 |
| 2 | Holstein | 15 | 16 | 3.24 | 3.37 | 3.57 | 3.88 | 29.8 | 27.3 | 145 | (13-285) | 148 | (20-324) | 2.8 | 2.7 |
| 3 | Holstein | 13 | 11 | 3.19 | 3.09 | 4.07 | 3.86 | 22.7 | 22.7 | 194 | (32-415) | 186 | (59-370) | 2.1 | 2.5 |
| 4 | Ayrshire | 27 | 16 | 3.42 | 3.42 | 4.31 | 4.43 | 20.4 | 20.4 | 156 | (8-368) | 137 | (9-247) | 2.1 | 2.5 |
| 5 | Holstein | 25 | 25 | 3.45 | 3.33 | 4.00 | 4.10 | 32.6 | 32.8 | 123 | (3-257) | 125 | (10-323) | 2.8 | 2.6 |
| 6 | Holstein | 9 | 9 | 3.40 | 3.67 | 4.18 | 4.18 | 26.9 | 25.6 | 111 | (36-220) | 203 | (4-766) | 2.2 | 2.4 |
| 7 | Holstein | 10 | 12 | 3.12 | 3.11 | 3.97 | 3.83 | 28.1 | 25.7 | 188 | (37-367) | 140 | (38-277) | 2.2 | 1.9 |
| 8 | Holstein | 21 | 22 | 3.46 | 3.34 | 4.08 | 3.55 | 34.4 | 37.7 | 126 | (4-359) | 168 | (8-339) | 2.2 | 2.3 |
| 9 | Holstein | 18 | 14 | 3.32 | 3.36 | 3.91 | 4.08 | 30.9 | 30.7 | 191 | (33-281) | 160 | (18-403) | 2.6 | 2.0 |
| 10 | Holstein | 16 | 14 | 3.40 | 3.39 | 3.87 | 3.79 | 28.8 | 29.0 | 145 | (29-315) | 136 | (8-296) | 2.6 | 2.0 |
| 11 | Holstein | 18 | 24 | 3.36 | 3.40 | 3.70 | 3.71 | 34.0 | 32.2 | 142 | (21-348) | 176 | (19-541) | 2.2 | 2.5 |
| 12 | Holstein | 13 | 13 | 3.32 | 3.26 | 4.13 | 3.90 | 32.0 | 35.6 | 159 | (18-305) | 156 | (45-398) | 3.1 | 3.2 |

| | | | | | | | | | | | | | | |
|---|---|---|---|---|---|---|---|---|---|---|---|---|---|---|
| Average (total) | (203) | (189) | 3.34 | 3.35 | 3.97 | 3.95 | 28.6 | 28.7 | 158 | 4-464 | 159 | 8-541 | 2.5 | 2.4 |

Results
Milk production

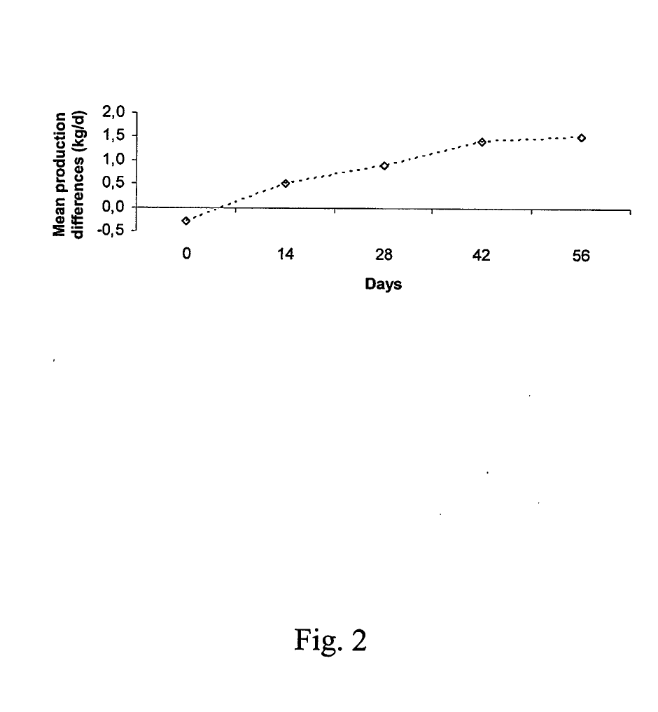

Results concerning milk production are presented in Table 6. The cows receiving flax seeds have shown a better persistency than the cows that received the reference feed (P<0.001). Indeed, after eight weeks, the cows that received flax seeds produced an additional 1.5 kg per day. As shown in FIG. 2, the difference between milk production of cows that received the reference feed and those that received flax seeds is increased up to the fifth data taking, since on day 0 the cows of the reference group produced more than 0.3 kg than those of the flax seed group and after 56 days, they produced 1.5 kg less.

Content and Milk Fat Production

No significant effect has been observed with respect to the milk fat content (P>0.10). Thus, milk fat percentage remains stable enough and no effect due to flax seeds has been identified. However, by jointly calling upon the time factor and the treatment, the effect becomes significant (P<0.05). There is a slight decrease of the fat content that tends to be compensated by a higher milk production. Increase in fat production has been observed (g/d) (<0.10).

Milk Fatty Acid Profile

The addition of flax seeds to cow feed has modified the composition of milk fat (table 4). Generally, short fatty acids (4 to 10 carbon atoms) have decreased, medium fatty acids (12 to 16 carbon atoms) have also decreased while long chain fatty acids (>18 carbon atoms) have increased.

With respect to short chain fatty acids, no difference has been noted between the reference group and the one receiving flax seeds for C4:0 and C6:0. However, C8:0 and C10:0 have significantly decreased (P<0.01).

The different medium chain fatty acids, of the group receiving flax seeds, were lower in all cases than those of the reference group, whether they are saturated or mono-unsaturated (P<0.01 to P<0.001 depending on the fatty acid).

The long chain fatty acid content has increased with the addition of flax seeds in the feed, while no significant difference could be determined for others. On the other hand, C18:1, cis-9, cis-12 had a tendency to decrease (P<0.10) when the animals received flax seeds.

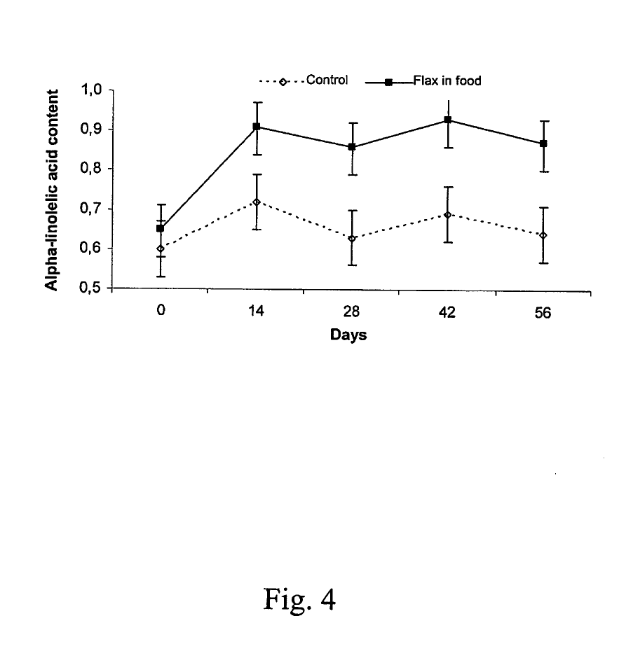

The total milk omega-3 fatty acid content (C18:3; C20:5 and C22:5) had increased when the cows were fed with flax seeds (FIG. 3). This is due to the increase of the α-linolenic acid content (C18:3) (P<0.001), since the eicosapentaenoic acid (EPA; C20:5) and docosapentaenoic acid acid (DPA; C22:5) contents remained stable (table 4). The C18:3 milk content of cows that received flax seeds was 35.9% higher after 56 days of experimentation. The average quantities of C18:3 were varied from 6.3 to 7.0 mg/g of fatty acids for the reference group and from 8.6 to 9.3 mg/g of fatty acids for the group that was fed with flax seeds (days 14, 28, 42 and 56) (FIG. 4).

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A method for inducing or increasing omega-3 lipid production by secretory tissue in a human or an animal comprising orally administering to said human or animal roasted flax seeds, fragment or derivatives thereof at a concentration inducing increase of the production of omega-3 in said secretory tissue.

2. The method of claim 1, wherein said secretory tissue is mammary glands.

3. The method of claim 1, wherein said animal is a lactating animal.

4. The method of claim 3, wherein said lactating animal is a cow, a sheep, or a goat.

5. The method of claim 1, wherein said flax seeds are whole, crushed, fragmented, or grinded.

6. A composition comprising roasted flax seeds for inducing or increasing omega-3 lipid production by secretory tissue in a human or an animal.

7. The composition of claim 6, wherein said secretory tissue is mammary glands.

8. The composition of claim 6, wherein said animal is a lactating animal.

9. The composition of claim 6, wherein said secretory tissue produce milk.

10. The composition of claim 6 being a food composition.

11. Use of roasted flax seed, a fragment or a derivative thereof for inducing or increasing omega-3 lipid production by secretory tissue of a human or an animal.

12. The use of claim 11, wherein said secretory tissue produce milk.

13. A body fluid obtained by the method of claim 1.

14. Use of roasted flax seeds, a fragment or a derivative there of in the preparation of a composition for inducing or increasing omega-3 lipid production by secretory tissue of a human of an animal.

15. The use of claim 14, wherein said composition is a food composition.

16. The use of claim 14, wherein said secretory tissue produce milk.
